(19) United States
(12) Patent Application Publication
(10) Pub. No.: US 2017/0073026 A1
(43) Pub. Date: Mar. 16, 2017

(54) VEHICLE COMBINATION WITH MULTIPLE DRIVEN VEHICLE MODULES

(71) Applicant: Scheuerle Fahrzeugfabrik GmbH, Pfedelbach (DE)

(72) Inventor: Ulrich Mugele, Pfedelbach (DE)

(21) Appl. No.: 15/363,830

(22) Filed: Nov. 29, 2016

Related U.S. Application Data
(63) Continuation of application No. PCT/EP2015/001132, filed on Jun. 3, 2015.

(30) Foreign Application Priority Data
Jun. 4, 2014 (DE) 10 2014 007 979.1
Jun. 4, 2014 (DE) 20 2014 004 510.0

(51) Int. Cl. B62D 59/04; B60P 3/40

(52) U.S. Cl. CPC B62D 59/04; B60P 3/40

(57) ABSTRACT

A vehicle combination includes at least one train having multiple driven vehicle modules. The vehicle modules are arranged one behind the other and are mechanically coupled to one another. Each vehicle module has at least one driven axle with at least one drive motor. The vehicle combination has at least one drive device for the drive motors that can generate the drive energy for said drive motors. The vehicle combination has at least one controller by means of which at least the drive motors of the driven axles of the vehicle modules can be actuated. The controller controls the drive motor or at least one of the drive motors of the driven axles of the vehicle modules of the at least one train of the vehicle combination across all the vehicle modules for the incremental selection of the total drive output of the vehicle combination.

### CROSS-REFERENCE TO RELATED APPLICATIONS

This continuation application claims priority to PCT/EP2015/001132 filed on Jun. 3, 2015 (which has published as WO 2015/185215 A1) and also German Application Nos. 10 2014 007 979.1 filed on Jun. 4, 2014 and 20 2014 004 510.0 filed on Jun. 4, 2014, the entire contents of which are fully incorporated herein with these references.

### FIELD OF THE INVENTION

The present invention generally relates to vehicles. More particularly, the present invention relates to a vehicle combination with several driven vehicle modules, each vehicle module having at least one driven axle with at least one drive motor, wherein the vehicle combination has at least one power unit for the drive motors of the axles of the vehicle modules, by which the energy required to drive the drive motors can be generated, and wherein the vehicle combination has at least one control means, by which at least the drive motors of the driven axles of the vehicle modules can be controlled, in particular can be switched on and off.

### BACKGROUND OF THE INVENTION

Known are modular heavy load vehicles with an integrated power unit, which are formed by coupling several vehicle modules side by side and/or one behind the other, so that by means of a mechanical connection of the vehicle modules a vehicle combination is formed. The individual vehicle modules have one or several axles, each are driven by at least one drive motor. The power unit of the vehicle combination has got a power pack with a combustion motor, which drives a pump arrangement for generating a hydraulic or a pneumatic pressure. Via pressure lines a pressure loaded pressure medium is led from the power pack of the power unit to the drive motors of the axles of the vehicle modules of the vehicle combination. It is also known that for driving one or several axles of one or several vehicle modules an electric motor is used as a power pack. In this case, the power unit has a generator which generates electric power, which is led via appropriate lines to the electric motors of the electrically driven axles.

A vehicle combination is known, which consists of a tractor and several trailers hauled by it. One or several of these trailers are provided as a vehicle module with at least one driven axle, which is supplied by the power pack with the energy required for driving the drive motors of the axles. The axles of the appropriate trailers are designed in such a way that the trailers can be hauled with a velocity high enough for a road transport, e.g. 80 km/h, whereby the axles drives are switched off. The reason for providing such a support drive is that in this way it is not required any more to provide, besides a tractor being positioned at the front end of the vehicle combination, a further, rear tractor, which is activated for overcoming of ascends.

Both in the known self-propelled vehicle combination as in a vehicle combination having a tractor and trailers coupled with it, it is provided up to now that the individual axles of the vehicle modules of the vehicle combination are equipped with the same drive motors and the controlling of these motors is only done within the same module, e.g. within a single vehicle module, e.g. within one single trailer. In a known self-propelled heavy duty vehicle it is provided that in a first drive step all axles are driven. In this way, a high traction force is achieved, which is required for starting the movement the vehicle combination loaded with a heavy load. With increasing speed of the vehicle combination, then in several driving or switching stages successively individual ones of the groups of axles of each vehicle module are switched off, until finally all axles of each vehicle module are switched off and are freewheeling. Such a design has got the disadvantage that it has got a low flexibility and, due to the few driving or switching stages, regularly a jerk free transition between the individual driving or switching stages is not given.

From DE 10 2012 023 622 B3 a land vehicle with undercarriages being arranged side by side and which are collectively moving and have their own drives for wheels or chains of the undercarriage, is known. Adjacent undercarriages are coupled via frame structures in such a way that the undercarriage always has at least one fixed bearing for coupling the frame structure and this frame structure is connected with an adjacent undercarriage by means of at least one loose bearing, wherein the loose bearing allows at least a limited movability in the longitudinal direction of the undercarriage, and whereby this arrangement is repeated in the other undercarriages. In this way a land vehicle is formed, which has got modular undercarriages, whereby the individual undercarriages are connected with each other movably. The individual undercarriages of this land vehicle therefore can move independently in the framework of the aforementioned loose coupling. The undercarriages therefore have got in the longitudinal direction of the vehicle a certain freedom, so that between the undercarriages, based on a line connecting the outer undercarriages, an offset is possible. To allow the undercarriages of this land vehicle to move collectively straight forward or go through a curve, it is provided that the drive of the wheels or the chains of the undercarriage is provided with at least one drive motor, a hydraulic pump driven by that drive motor and at least one controllable valve for the oil flow from the hydraulic pump to the hydraulic motor for driving the wheels, whereby the controllable valve is centrally controllable and downstream of said controllable valve at least one sensor controllable valve for the oil flow is arranged.

WO 2004/074031 A1 describes a vehicle combination, which has got a tractor, to which several non-driven trailers are coupled. Then a driven trailer follows, to which further non-driven trailers are coupled, etc. The tractor comprises a power unit, which is controlled via a foot throttle. The power unit of the driven trailer is controlled via a hand throttle. This document therefore relates to a control system for a vehicle, which can be operated by a driver, whereby the vehicle has got at least two power units and one brake unit, namely a foot throttle control unit, which can be operated by the driver, which exclusively acts on the first power unit, and a second throttle control unit, which exclusively acts on the power unit of the driven trailer. The system known from this document is designated to control the power unit of the driven trailer in the case of an emergency braking in such a way that its drive power is independent from the position of the hand throttle. In this way it should be achieved that in case of an emergency braking, when the driver is not capable to operate the hand throttle, that the power unit of the driven trailer does not drive in the case of such an emergency braking the vehicle combination any more: when the tractor is braked hard, the system checks whether or not the hand throttle of the trailer is in its idle running position. If this is the case, i.e. if the power unit is running in its idle condition, no further action has got to be taken. If the systems finds in the case of an emergency braking, that the hand throttle is activated, then the power unit of the trailer is switched running idle and the gear is decoupled. Then further security checks are performed. It is essential that the control unit only acts on the drive unit of the driven trailer.

EP 2 062 837 A1 describes a conveyor system and a method for its operation. The floor conveyor system includes a plurality of identical, autonomously operatable transport units, which can communicate with each other, can identify one another and can form functionally, but not mechanically a compound consisting of several transport units. The floor conveyor system has got a control center communicating with the transport units and identifying them. For operating the floor conveyor system it is provided that in the control center jobs to be processed are collected in a job pool, whereby at least the pick-up location and the delivery location of the load as well as the number of transport units resulting therefrom is stored. A free transport unit then selects a job and accepts it. It then moves to the pick-up location and asks the control center if the required number of further transport units have accepted the job. If this is not the case, it calls at the control center for further transport units and/or, by means of a direct communication, with further transport units, it calls these. The load is then taken up and transported from the pick-up location to the delivery location.

DE 10 2012 102 648 A1 describes a modular ground transportation system, which is in particular self-propelled and designed for heavy assembly and logistic processes. It is provided that individual transport modules of the ground transportation system join for a larger ground transport, wherein the transport modules are coupled together. The control units of the transport modules communicate with each other, in order to achieve a uniform driving and steering movement of the larger ground transportation system in all directions.

WO 2007/062640 A1 describes a vehicle combination composed of a plurality of individual vehicles comprising a chassis. An individually driven and braked wheel is disposed at least on one individual vehicle. Said wheel encompasses a wheel support with rolling members that are arranged on the circumference of the wheel support and are provided with a convex contour and whose axes of rotation are placed at an angle from the axis of rotation of the wheel support to allow a movement of the individual vehicle in all directions of the plane of travel. The individual vehicles are mechanically coupled to each other via joining elements, while the wheel drives of the individual vehicles can be selectively triggered on an individual basis via a combined controller. The mechanical connection of the individual vehicles does not allow a relative movement in respect to each other in the plane of travel, so that a secure positioning of loads on the individual vehicles is possible without the danger that individual vehicles travel their own way. By means of the combined controller it is possible to control the wheel drives in such a way that only the wheel required is driven, so that the individual vehicles with in general four driven wheels form vehicle combination, the wheels of which can be selectively controlled, and whereby it is particularly provided that in the vehicle combination the driven wheels are arranged at the edges, whereby the inner wheels are switched off or used as support drives.

It is therefore the object of the present invention to further develop a vehicle combination of the aforementioned type such that an improved adaption of the individual drive stages of the driven vehicle modules to the actual drive situation of the vehicle combination can be achieved.

### SUMMARY OF THE INVENTION

This object is achieved by the invention in that the control means controls the at least one of the drive motors of the driven axles of at least two vehicle modules of the at least train of the vehicle combination for a graduation of the total drive power across the vehicle modules.

According to the invention it is therefore provided that the control means not only switches on or off one or several specific axles of each individual vehicle module of the vehicle combination in a vehicle module internal way, but that by means of the inventive control means specifically different axles of different vehicle modules of the vehicle combination are controllable. The controlling of individual axles of the driven vehicle modules of the vehicle combination therefore is done in an advantageous way across vehicle modules. Such a measure has got the advantage that in this way an improved graduation of the drive power of the axles of the vehicle combination formed by the coupled vehicle modules is achieved.

By virtue of the vehicle module overlapping, individual controlling of at least two and preferably of all or at least nearly all driven axles of the vehicle modules of the vehicle combination in an advantageous way an improved graduation of the drive power, in particular at higher velocities, and thus an improved driving behavior of the vehicle combination is achieved. For a high traction force, which is required to initiate moving and at low velocities as well as in a support operation, all or at least nearly all driven axles are active, and, as speed increases, individual axles can be switched off, depending on the traction force required.

An advantageous further development of the invention provides that in at least one vehicle module of the vehicle combination at least two axles have got drive motors with a different dimensioning. Such a measure has got the advantage that in this way a further improved graduation of the drive power of the inventive vehicle combination can be achieved, without requiring a complex controlling and/or regulating of the individual drive motors of the individual axles.

A further advantageous development of the invention provides that at least one drive motor is a hydraulic motor. If now different axles of one or several vehicle modules of the vehicle combination are provided with different sized hydraulic motors, which have, due to their different dimensioning, different displacements, the measures according to the invention allow in an advantageous way an improved adaption of the displacement of the hydraulic motors in respect to a specific driving situation.

Further advantageous developments of the invention are the subject matter of the dependent claims.

### BRIEF DESCRIPTION OF THE DRAWINGS

Further details and advantages of the invention are disclosed in the exemplary embodiments, which are described below with reference to the figures. It shows:

FIG. 1 is a first exemplary embodiment of a vehicle combination;

FIG. 2 is a second exemplary embodiment of a vehicle combination;

FIG. 3 is a third exemplary embodiment of a vehicle combination; and

FIG. 4 is a fourth exemplary embodiment of a vehicle combination.

### DETAILED DESCRIPTION OF THE PREFERRED EMBODIMENTS

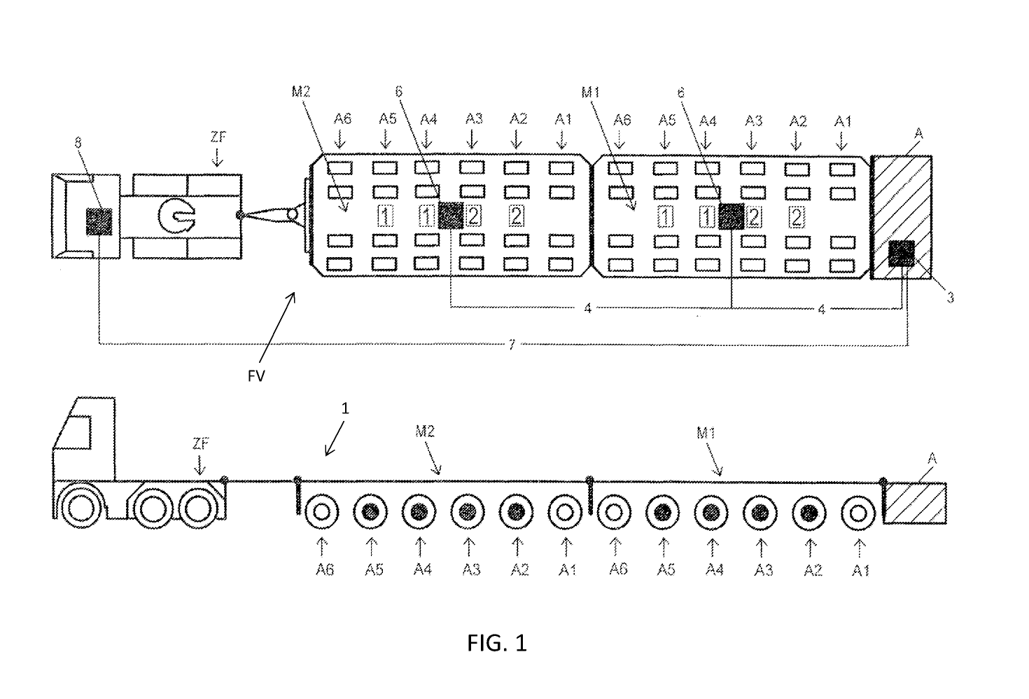

In FIG. 1 an exemplary embodiment, generally designated with 1, of a vehicle combination FV is shown, which is in the case described designed as a hauled vehicle combination FV. It has got two vehicle modules M1, M2, which are arranged in the direction of travel of the vehicle combination FV in succession and are mechanically coupled with each other and form in that way a train Z1 of the vehicle combination FV. Each vehicle module M1, M2 has got, in the case shown, six axles A1 to A6, wherein the second and the third axle A2 and A3 as well as the fourth and fifth axle A4 and A5 are driven by means of a drive motor 1 and 2 respectively, which are shown in the Figures only schematically. The first and the sixth axle A1 and A6 are not driven. It is evident for the person skilled in the art that the number of six axles A1-A6 as well as the arrangement of the driven axles A1-A6 only have got exemplary character. Of course the number and arrangement of the driven axles can vary.

The vehicle combination FV comprises a tractor ZF and a power unit A, which serves for generating the energy required for driving the drive motors 1 and 2 of the vehicle modules M1, M2. In the case shown here it is provided, as an example, that the drive motors 1 and 2 are designed as hydraulic motors. The power unit A has a power pack (not shown), which has a combustion engine, which drives a pump arrangement for generating a hydraulic pressure. By means of pressure lines, not shown in the Figures, a pressure medium, which is pressure loaded by the power pack of the power unit A, is led to the drive motors 1 and 2. Of course it is possible to use instead of hydraulic motors pneumatically driven motors. In this case the power unit A generates a pneumatic pressure medium. The use of electric motors is possible too. Also conceivable, but not preferred is a combination of the aforementioned types of drive motors.

The vehicle combination FV has got a control means 3, which is connected via control lines 4 with the drive motors 1, 2 of the axles A2, A5 of the vehicle modules M1, M2. Of course it is possible to provide a wireless connection between the control means and the drive motors 1, 2 of the axles A2, A5. The drive means 3 serves to control, in conjunction with control means 6 of the vehicle modules M1, M2, the drive motors 1, 2 of the vehicle modules M1, M2, whereby the expression “controlling” not only denotes a controlling in a narrow sense, but a “regulating” of the drive motors 1, 2 too.

Contrary to known vehicle combinations, where the control of the drive motors 1 and 2 is limited to a single vehicle module M1, M2 only, it is provided that the controlling of the axles A2-A5 of the vehicle modules M1, M2 of the train Z1 for grading the total drive power of the vehicle combination FV is done across the vehicle modules, i.e. not limited to a single vehicle module, but is performed vehicle combination based. The control means 3 is therefore equipped and configured in such a way that it, depending on the transport performance to be actually provided by the vehicle combination FV, i.e. depending on the total drive power required in a certain driving situation, and hence depending on the drive power to be supplied by the driven axles A2-A5, controls the axles A2-A5 of the first vehicle module M1 as well as of the second vehicle module M2 individually. The control means 3 is therefore, in cooperation with the control means 6 of the vehicle modules M1, M2, capable to individually switch individual axles A2-A5 of the individual vehicle modules M1 and M2 on and off, so that in this way a graduation of the total drive power of the vehicle combination FV can be achieved. This shall be explained by the following example:

When starting a vehicle combination FV, e.g. a hauled vehicle combination, which is loaded with a corresponding heavy load, a large drive power is required. In this case it is provided in the exemplary embodiment as an example that all the axles A2-A5 of both vehicle modules M1 and M2 are active and contribute to the starting of the vehicle combination FV. If the vehicle combination FV has started to move, a smaller traction force is required for the further movement thereof. The traction force, which is required for starting the vehicle combination therefore, can be reduced and the driving speed can be increased. For that purpose the control means 3, as an example, switches off one axle, e.g. the second axle A2 of the second vehicle module M2. Then, for a further reduction of the drive power a further axle, e.g. the third axle A3 of the second vehicle module M2, is switched off.

By means of a successive shutdown of further axles of the vehicle modules M1, M2 of the vehicle combination FV the traction force is then reduced step-by-step and the driving speed is increased.

The aforementioned example shows that by virtue of a controlling of the driven axles A2-A5 across the vehicle modules and directed to the vehicle combination itself, a plurality of driving and switching steps and hence a finer graduation of the drive power of the vehicle combination FV is achieved.

Preferably it is provided that the individual vehicle modules M1, M2 have differently dimensioned drive motors 1, 2. In the example described here it is provided that the drive motors designated with 1 of the fourth and fifth axles A4 and A5 of the two vehicle modules M1, M2 have got a higher displacement as the drive motor denoted with 2 of the second and third axles A2 and A3 of the vehicle modules M1 and M2. As an example, for the drive motors 1 a hydraulic motor with a displacement of 1248 cm3 can be used and for the drive motors 2 it can be provided that these are designed as hydraulic motors with a displacement of 627 cm3. By using such configured drive motors 1, 2 in an advantageous way an even finer graduation of the driving stages of the vehicle combination FV can be achieved.

By means of an operating unit 8, which is connected via a control line 7 or wireless with the control means 3, different drive conditions can be displayed and adaptions to the driving behavior can be performed.

It is conceivable too that by means of a direct connection of the drive motors 1, 2 of the axles A2-A5 of the vehicle modules M1, M2 with the control means 3 the control means 6 of the vehicle modules M1, M2 can be omitted.

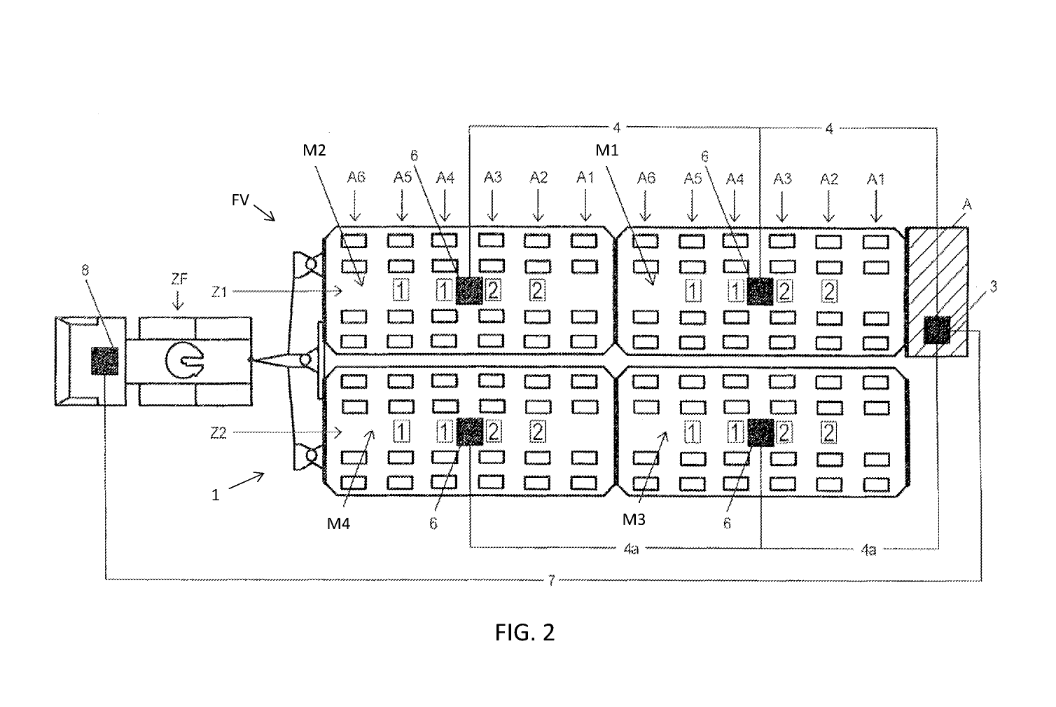

In FIG. 2 a second exemplary embodiment of a vehicle combination FV is shown, in which corresponding components are denoted with the same reference signs and are not described once more. The main difference between the first and the second exemplary embodiment is that the vehicle combination FV of the second exemplary embodiment not only has got vehicle modules M1 and M2 like in the first exemplary embodiment, but has got further vehicle modules M3 and M4, wherein the vehicle modules M3 and M4—like the vehicle modules M1 and M2—are coupled with each other by mechanical means. The vehicle modules M1 and M2 and the vehicle modules M3 and M4 respectively in this way form two parallel, juxtaposed trains Z1 and Z2 of the vehicle combination FV, which are connected via mechanical cross-linking means, which are not shown. The control means 3 is—like in the first embodiment—connected via control lines 4 with the axles A2-A5 of the first and the second vehicle module M1 and M2.

In addition to that, a second control line 4a is provided, which connects the control means 3 of the vehicle combination FV with the axles A2-A5 of the third and fourth vehicle module M3 and M4. The control means 3 thus can individually control the axles A2-A5 of the first and the second vehicle module M1 and M2 of the first train Z1 as well as the axles A2-A5 of the third and fourth vehicle module M3 and M4 of the second train Z2. It is preferred too that the drive motors 1 and 2 of the vehicle modules M1-M4 are provided with different displacements.

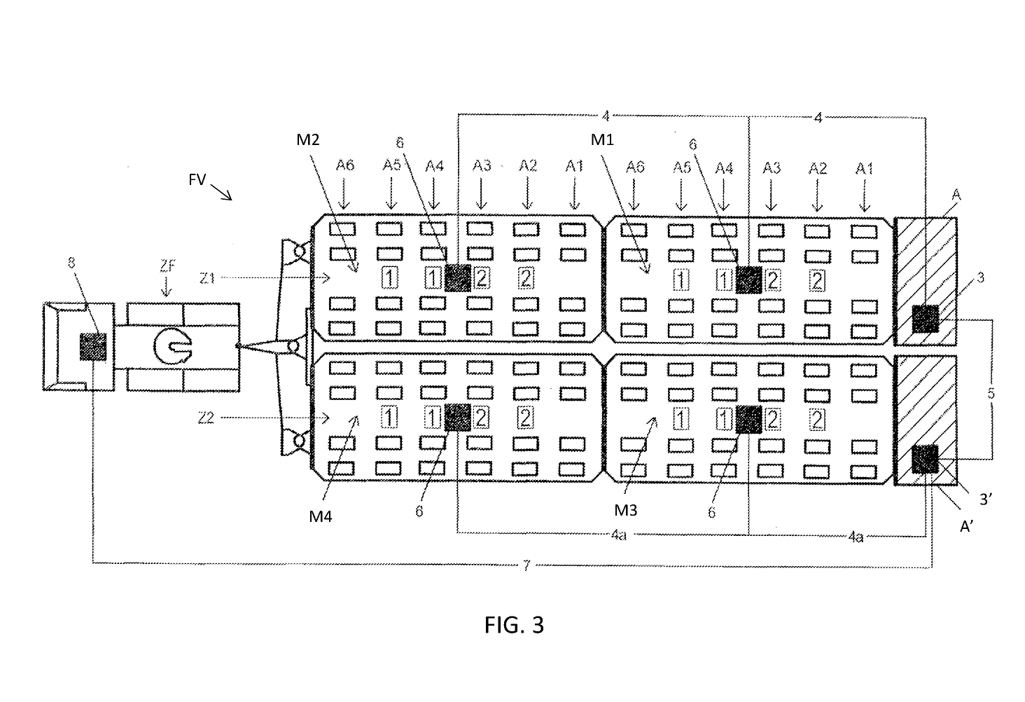

In FIG. 3 a third exemplary embodiment of a vehicle combination FV is shown, which corresponds in its basic layout with the one of the second exemplary embodiment. So here there are once more two trains Z1 and Z2 with two vehicle modules M1 and M2 and M3 and M4 respectively are provided. The main difference between the second and third exemplary embodiment is that not only the first train Z1 of the vehicle combination FV comprising the vehicle modules M1 and M2 has got a power unit A with a control means 3, but that the second train Z2 has got a power unit A′ corresponding to the power unit A and a control means 3′ corresponding to the control means 3.

The control means 3 is connected via the control line 4 with the axles A2-A5 of the first vehicle module M1 and M2, whereas the further control line 4a connects the control means 3′ with the axles A2-A5 of the third and fourth vehicle module M3 and M4. In addition it is provided that the control means 3 and 3′ are connected via a—preferably bi-directional—control line 5 or wireless, with each other, so that a communication between these control means 3 and 3′ is possible.

The aforementioned embodiments assume that the vehicle combination FV is formed as a hauled vehicle combination with a support drive, as it is e.g. provided by vehicles of the type InterCombi of the applicant.

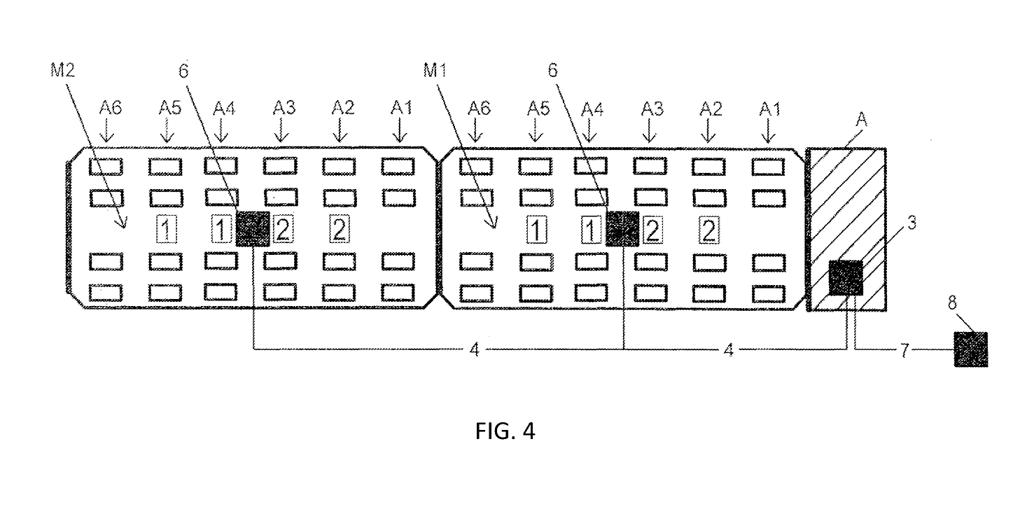

However, it is possible to use the described configuration of the vehicle modules M1-M4 in a self-propelled vehicle combination too, i.e. in a vehicle combination, in which the vehicle modules M1-M4 are driven by power units of the vehicle modules M1, M2. FIG. 4 shows such a structure. The main difference between the exemplary embodiment of FIG. 4 and the one of FIG. 1 is that no tractor ZF is provided upstream of the vehicle modules M1 and M2. The drive means provided by the axles A2-A5 of the vehicle modules M1 and M2 in connection with the power pack A serves for driving the vehicle combination in a self-propelled way. Again, the described measures allow an improved adaption of the drive power of the drive and improve overall drivability of the vehicle combination as well as the reaching of higher driving speeds.

What is claimed is:

1. A vehicle combination with at least one train comprising at least two driven vehicle modules, in which the driven vehicle modules belonging to the at least one train are arranged in a drive direction of the vehicle combination one after the other and are mechanically coupled, each driven vehicle module having at least one driven axle with at least one drive motor, the vehicle combination having at least one power unit for the drive motors of the driven axles of the driven vehicle modules, through which a drive energy required for driving each drive motor can be generated, the vehicle combination having at least one control means, by which each drive motor of the each driven axle of each driven vehicle module can be controlled, wherein the at least one control means controls at least one of the drive motors of the driven axles of at least two vehicle modules of the at least one train of the vehicle combination for graduating the total drive power of the vehicle combination across the vehicle modules.

2. The vehicle combination according to claim 1, wherein at least one driven vehicle module of the vehicle combination has at least two differently dimensioned drive motors.

3. The vehicle combination according to claim 1, wherein the at least one train of the vehicle combination is provided with the at least one power unit and the at least one control means, and that the at least one control means controls the drive motor or the drive motors of the driven axles of the at least two driven vehicle modules.

4. The vehicle combination according to claim 1, wherein the vehicle combination comprises a second train having at least two driven vehicle modules each driven vehicle module also having at least one driven axle with at least one drive motor.

5. The vehicle combination according to claim 4, wherein the control means of the at least one train controls the drive motor or the drive motors of the driven axles of said second train.

6. The vehicle combination according to claim 4, wherein the second train comprises a second power unit and a second control means, and that said second control means controls the drive motor or the drive motors of the driven axles of the driven vehicle modules of said second train.

7. The vehicle combination according to claim 6, wherein the control means of the at least one train and the second control means of said second train are connected via a control line.

8. The vehicle combination according to claim 1, wherein at least one of the at least two driven vehicle module has a vehicle module internal control means which is connected with the at least one control means.

9. The vehicle combination according to claim 8, wherein the at least one control means is connected with an operating unit.

10. The vehicle combination according to claim 1, wherein by means of the at least one control means the drive motor or the drive motors of the driven axles of the driven vehicle modules can be switched on and off.
